(19) United States
(12) Patent Application Publication
(10) Pub. No.: US 2023/0196202 A1
(43) Pub. Date: Jun. 22, 2023

(54) SYSTEM AND METHOD FOR AUTOMATIC BUILDING OF LEARNING MACHINES USING LEARNING MACHINES

(71) Applicant: DarwinAI Corporation, Waterloo (CA)

(72) Inventors: ALEXANDER SHEUNG LAI WONG, Waterloo (CA); MOHAMMAD JAVAD SHAFIEE, Waterloo (CA); FRANCIS LI, Waterloo (CA)

(21) Appl. No.: 18/082,522

(22) Filed: Dec. 15, 2022

Related U.S. Application Data
(63) Continuation of application No. 17/529,142, filed on Nov. 17, 2021, now abandoned.
Application No. 17/529,142 is a continuation of application No. 15/982,478, filed on May 17, 2018, now abandoned.
(60) Provisional application No. 62/623,615, filed on Jan. 30, 2018.
(60) Provisional application No. 62/529,474, filed on Jul. 7, 2017.

(51) Int. Cl. G06N 20/00; G06N 3/084; G06N 3/045

(52) U.S. Cl. CPC G06N 20/00; G06N 3/084; G06N 3/045

(57) ABSTRACT

Systems, devices and methods are provided for building learning machines using learning machines. The system generally includes a reference learning machine, a target learning machine being built, a component analyzer module configured to analyze inputs from the reference learning machine, the target learning machine, a set of test signals, and a list of components in the reference learning machine and the target learning machine, and return a set of output values for each component on the list of components. The system further includes a component tuner module configured to modify different components in the target learning machine based on the set of output values and a component mapping, thereby resulting in a tuned learning machine.

### CROSS REFERENCE TO RELATED APPLICATIONS

The present application is a continuation of U.S. patent application Ser. No. 17/529,142, filed Nov. 17, 2021, which is a continuation of U.S. patent application Ser. No. 15/982,478, filed May 17, 2018, now abandoned, which claims priority to U.S. Provisional Patent Application No. 62/529,474, filed Jul. 7, 2017, and U.S. Provisional Patent Application No. 62/623,615, filed Jan. 30, 2018, the entire contents and disclosures of which are hereby incorporated by reference.

### FIELD OF THE INVENTION

The present disclosure relates generally to the field of machine learning, and more particularly to systems and methods for building learning machines.

### BACKGROUND OF THE INVENTION

Learning machines are machines that can learn from data and perform tasks. Examples of learning machines include kernel machines, decision trees, decision forests, sum-product networks, Bayesian networks, Boltzmann machines, and neural networks. For example, graph-based learning machines such as neural networks, sum-product networks, Boltzmann machines, and Bayesian networks typically consist of a group of nodes and interconnects that are able to process samples of data to generate an output for a given input and learn from observations of the data samples to adapt or change.

One of the biggest challenges in building learning machines is in designing and building efficient learning machines that can operate for situations with low-cost or low-energy needs. Other big challenges include designing and building learning machines with no labeled data or with limited labeled data. As learning machines can often require significant amount of data to train after it has been built, creating a large set of labeled data by having human experts manually annotate all the data to train such learning machines is very time-consuming, and requires significant human design input. Methods exist for building learning machines using unlabeled data or limited labeled data; however, they are limited in their ability to build a wide variety of learning machines with different architectures or dynamically changing architectures and can be very computationally expensive as they often require large portions of components or even all components in the learning machine. In addition, building graph-based learning machines, such as neural networks and the like, often require human experts to design and build these learning machines by hand to determine the underlying architecture of nodes and interconnects. The learning machine will then need to be optimized through trial-and-error, based on experience of the human designer, and/or use of computationally expensive hyper-parameter optimization strategies.

A need therefore exists to develop systems and methods for building learning machines without the above mentioned and other disadvantages.

### SUMMARY OF THE INVENTION

The present disclosure relates generally to the field of machine learning, and more specifically to systems and methods for building learning machines.

Provided herein are example embodiments of systems, devices and methods are provided for building learning machines using learning machines. A system generally may include a reference learning machine, a target learning machine being built, a component analyzer module configured to analyze inputs from the reference learning machine, the target learning machine, a set of test signals, and a list of components in the reference learning machine and the target learning machine and return a set of output values for each component on the list of components. The system may further include a component tuner module configured to modify different components in the target learning machine based on the set of output values and a component mapping, thereby resulting in a tuned learning machine.

In an aspect of some embodiments, the system may include a feedback loop for feeding back the tuned learning machine as a new target learning machine in an iterative manner.

In an aspect of some embodiments, the target learning machine may be a new component to be inserted into the reference learning machine.

In an aspect of some embodiments, the target learning machine replaces an existing set of components in the reference learning machine.

In an aspect of some embodiments, the reference learning machine and the target learning machine are graph-based learning machines.

In an aspect of some embodiments, the component analyzer module is a node analyzer module.

In an aspect of some embodiments, the component tuner module is an interconnect tuner module.

In an aspect of some embodiments, the component mapping is a mapping between nodes from the reference learning machine and nodes from the target learning machine.

In an aspect of some embodiments, the interconnect tuner module updates interconnect weights in the target learning machine.

In an aspect of some embodiments, the tuned learning machine includes components updated by the component tuner module.

In some embodiments, systems, devices and methods are provided for building learning machines using data. A system generally may include an initial graph-based learning machine, a machine analyzer configured to analyze components of the initial graph-based learning machine based on a set of data to generate a set of machine component importance scores, and a machine architecture builder configured to build a graph-based learning machine architecture based on the set of machine component importance scores and a set of machine factors.

In an aspect of some embodiments, a new graph-based learning machine may be built wherein the architecture of the new graph-based learning machine is the same as the graph-based learning machine architecture.

In an aspect of some embodiments, a feedback loop for feeding back the new graph-based learning machine as a new initial graph-based learning machine in an iterative manner.

In an aspect of some embodiments, the machine analyzer may be further configured to feed each data point in a set of data points from the set of data into the initial graph-based learning machine for a predetermined set of iterations, select groups of nodes and interconnects in the initial graph-based learning machine with each data point in the set of data points to compute an output value corresponding to each machine component in the initial graph-based learning machine, compute an average of a set of computed output values of each machine component for each data point in the set of data points to produce a combined output value of each machine component corresponding to each data point in the set of data points, and compute a machine component importance score for each machine component by averaging final combined output values of each machine component corresponding to all data points in the set of data points from the set of data and dividing the average by a normalization value.

In an aspect of some embodiments, the machine analyzer may be further configured to feed each data point in a set of data points from the set of data into the initial graph-based learning machine for a predetermined set of iterations, randomly select groups of nodes and interconnects in the initial graph-based learning machine with each data point in the set of data points to compute an output value corresponding to one of the nodes of the initial graph-based learning machine, average a set of computed output values for each data point in the set of data points to produce a final combined output value corresponding to each data point, and compute a full machine score for each component in the initial graph-based learning machine by averaging a final combined output value corresponding to all data points in the set of data.

In an aspect of some embodiments, the machine analyzer may be further configured to feed each data point in the set of data points from the set of data into a reduced graph-based learning machine, with at least some machine components excluded, for a predetermined set of iterations, randomly select groups of nodes and interconnects in the reduced graph-based learning machine with each data point in the set of data points to compute an output value corresponding to one of the nodes of the reduced graph-based learning machine, compute an average of a set of computed output values for each data point to produce a final combined output value corresponding to each data point, and compute a reduced machine score for each component in the reduced graph-based learning machine by averaging a final combined output value corresponding to all data points in the set of data points in the set of data.

In an aspect of some embodiments, the machine architecture builder may be further configured to control the size of the new graph-based learning machine architecture based on the set of machine component importance scores and the set of machine factors.

In an aspect of some embodiments, the machine architecture builder may control the size of the new graph-based learning machine architecture by determining whether each node will exist in the new graph-based learning machine architecture.

In an aspect of some embodiments, the machine component importance score for a specific data point may be computed as: the full machine score for a specific data point/(the full machine score for a specific data point+the reduced machine score for a specific data point).

In an aspect of some embodiments, the machine component importance score may be computed as: the full machine score/(the full machine score+the reduced machine score).

In an aspect of some embodiments, the system may compute a final set of machine component importance scores for each node and each interconnect in the graph-based learning machine by setting each machine component importance score to be equal to the machine component importance score of the machine component each node and each interconnect belongs to.

In an aspect of some embodiments, the machine architecture builder may determine whether each node will exist in the new graph-based learning machine architecture by: generating a random number with a random number generator and adding the node in the new graph-based learning machine architecture if the importance score of that particular node multiplied by a machine factor is greater than the random number.

In an aspect of some embodiments, the machine architecture builder may determine whether each interconnect will exist in the new graph-based learning machine architecture by: generating a random number with the random number generator and adding the interconnect in the new graph-based learning machine architecture if the importance score of that particular interconnect multiplied by a machine factor is greater than the random number.

In an aspect of some embodiments, the random number generator may be configured to generate uniformly distributed random numbers.

In an aspect of some embodiments, the machine architecture builder may be configured to determine whether each node will exist in the new graph-based learning machine architecture by comparing whether the importance score of a particular node is greater than one minus a machine factor, and if so, adding the node in the new graph-based learning machine architecture.

In an aspect of some embodiments, the machine architecture builder may determine whether each interconnect will exist in the new graph-based learning machine architecture by adding the interconnect in the new graph-based learning machine architecture if the importance score of that particular interconnect is greater than one minus a machine factor.

In some embodiments, systems, devices and methods are provided for building learning machines. A system generally may include a reference learning machine, a target learning machine being built, a node analyzer module configured to analyze inputs from the reference learning machine, the target learning machine, a set of test signals, and a list of nodes in the reference learning machine and the target learning machine, and return a set of output values for each component on the list of nodes, an interconnect tuner module configured to modify different components in the target learning machine based on the set of output values and a node mapping, thereby resulting in a tuned learning machine, an initial graph-based learning machine, a machine analyzer configured to analyze components of the initial graph-based learning machine based on a set of data to generate a set of machine component importance scores, and a machine architecture builder configured to build a graph-based learning machine architecture based on the set of machine component importance scores and a set of machine factors.

In an aspect of some embodiments, a new graph-based learning machine is built wherein the architecture of the new graph-based learning machine is the same as the graph-based learning machine architecture.

In an aspect of some embodiments, the tuned learning machine is fed into the machine analyzer as the initial graph-based learning machine.

In an aspect of some embodiments, the new graph-based learning machine is fed into node analyzer module as the reference learning machine.

These embodiments and others described herein are improvements in the fields of machine learning and, in particular, in the area of computer-based learning machine building. Other systems, devices, methods, features and advantages of the subject matter described herein will be apparent to one with skill in the art upon examination of the following figures and detailed description. The various configurations of these devices are described by way of the embodiments which are only examples. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 illustrates an exemplary diagram of a system for building learning machines, according to an embodiment of the disclosure.

FIG. 2 illustrates an exemplary diagram of a system for building graph-based learning machines, according to an embodiment of the disclosure.

FIG. 3 illustrates an exemplary diagram of a node analyzer module for building graph-based learning machines, according to an embodiment of the disclosure.

FIG. 4 illustrates an exemplary diagram of an interconnect tuner module for building graph-based learning machines, according to an embodiment of the disclosure.

FIG. 5 illustrates an exemplary diagram of a system for building learning machines wherein the target graph-based learning machine is being built for a task pertaining to object recognition, according to an embodiment of the disclosure.

FIG. 6 illustrates an exemplary diagram of a system for building graph-based learning machine using data, according to an embodiment of the disclosure.

FIGS. 7A-7B illustrate an exemplary flow diagram for the system of FIG. 6, according to an embodiment of the disclosure.

FIG. 8 illustrates an exemplary diagram of a system of the system of FIG. 6 with a feedback loop, according to an embodiment of the disclosure.

FIG. 9 illustrates an exemplary diagram of a system illustrating an exemplary application of the system of FIG. 6 and FIG. 8, according to an embodiment of the disclosure.

FIG. 10A illustrates an exemplary schematic block diagram of an illustrative integrated circuit with a plurality of electrical circuit components that may be used to build an initial reference artificial neural network, according to an embodiment of the disclosure.

FIG. 10B illustrates an exemplary schematic block diagram of an illustrative integrated circuit embodiment with a system-generated reduced artificial neural network, according to an embodiment of the disclosure.

FIGS. 11A-11B illustrate examples of a reference artificial neural network corresponding to the FIG. 10A block diagram, and a more efficient artificial neural network built in accordance with the present disclosure corresponding to the FIG. 10B block diagram, according to an embodiment of the disclosure.

FIG. 12 illustrates an exemplary combination of embodiments of systems and methods of FIG. 2 and FIG. 8 combined for building graph-based learning machines, according to an embodiment of the disclosure.

FIG. 13A illustrates an exemplary schematic block diagram of another illustrative integrated circuit with a plurality of electrical circuit components that may be used to build an initial reference artificial neural network, according to an embodiment of the disclosure.

FIG. 13B illustrates an exemplary schematic block diagram of another illustrative integrated circuit embodiment with a system-generated reduced artificial neural network, according to an embodiment of the disclosure.

FIG. 14 illustrates an exemplary embodiment of systems and methods of FIG. 12 and a repository of learning machines combined for building graph-based learning machines, according to an embodiment of the disclosure.

FIG. 15 illustrates an exemplary embodiment of a logic unit in a repository of learning machines, according to an embodiment of the disclosure.

FIG. 16 illustrates another exemplary diagram of a system for building learning machines using learning machines and a repository of learning machines, according to an embodiment of the disclosure.

FIG. 17 illustrates an exemplary computing device, according to an embodiment of the disclosure.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

### Automatic Building of Learning Machines Using Learning Machines

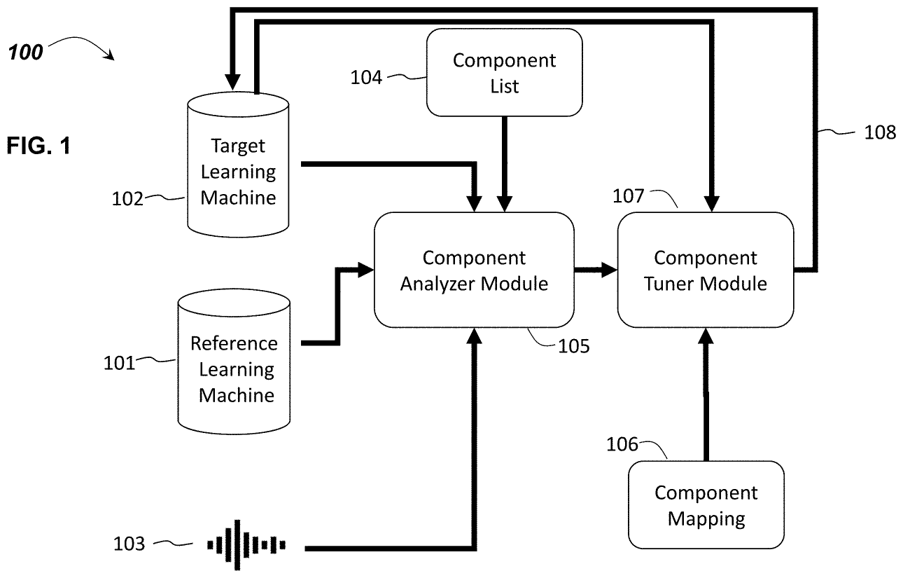

FIGS. 1-17 illustrate exemplary embodiments of systems and methods for building learning machines. Generally, the present system may include a reference learning machine, a target learning machine being built, a component analyzer module, and a component tuner module. In some embodiments, the reference learning machine, the target learning machine, a set of test signals, and a list of components in the learning machines to analyze are fed as inputs into the component analyzer module. The component analyzer module may use the set of test signals to analyze the learning machines and returns a set of output values for each component on the list of components. The set of output values for each component that is analyzed, along with a mapping between the components from the reference learning machine and the components from the target learning machine, and the target learning machine, are passed as inputs into a component tuner module. The component tuner module modifies different components in the target learning machine based on the set of output values and the mapping, resulting in a tuned learning machine. The learning machines in the system may include, for example, kernel machines, decision trees, decision forests, sum-product networks, Bayesian networks, Boltzmann machines, and neural networks.

The embodiments of the present disclosure provide for improvements that can include, for example, optimization of computer resources, improved data accuracy and improved data integrity, to name only a few. In some embodiments, for example, the component analyzer module and the component tuner module may be embodied in hardware, for example, in the form of an integrated circuit chip, a digital signal processor chip, or on a computer. In some embodiments, learning machines built by the present disclosure may be also embodied in hardware, for example, in the form of an integrated circuit chip or on a computer. Thus, computer resources can be significantly conserved. The number of component specifications (for example, the weights of interconnects in graph-based learning machines such as neural networks) in learning machines built by the present disclosure may be greatly reduced, allowing for storage resources to be significantly conserved. The learning machines built by the present system, which can have significantly fewer components, may also execute significantly faster on a local computer or on a remote server.

In some embodiments, the tuned learning machine may be fed back through a feedback loop and used by the system and method as the target learning machine in an iterative manner.

In some embodiments, the target learning machine being built may be a new component designed to be inserted into the reference learning machine or to replace an existing set of components in the reference learning machine. In some embodiments, the target learning machine may be a modification of the reference learning machine with either an extended set of components, a reduced set of components, or a modified set of components. This may allow existing learning machines to have their architectures modified, including being modified dynamically over time.

To ensure the integrity of the data, several data validation methods may also be provided. For example, the learning modules, data, and test signals are checked and validated before sending to the next modules of the present disclosure to ensure consistency and correctness. The range of data and test signals may also be checked and validated to be within acceptable ranges for the different types and configurations of learning machines.

Turning to FIG. 1, an exemplary diagram of a system 100 for building learning machines is illustrated, according to some embodiments of the disclosure. System 100 may include a reference learning machine 101, a target learning machine being built 102, a set of test signals 103, a list of components to analyze 104, a component analyzer module 105, a mapping 106 between the components in reference learning machine 101 and the components in target learning machine 102, a component tuner module 107, and a feedback loop 108. The learning machines in the system may include: kernel machines, decision trees, decision forests, sum-product networks, Bayesian networks, Boltzmann machines, and neural networks. In one aspect of some embodiments, the reference learning machine 101, the target learning machine 102, the set of test signals 103, and the list of components 104 in the learning machines to analyze may be fed as inputs into the component analyzer module 105. The component analyzer module 105 may use the set of test signals 103 to analyze the learning machines 101 and 102, and may return a set of output values for each component on the list of components 104. The set of output values for each component that is analyzed, along with the mapping 106 between the components from the reference learning machine 101 and the components from the target learning machine 102, and the target learning machine 102, may be passed as inputs into a component tuner module 107. The component tuner module 107 may modify different components in the target learning machine 102 based on the set of output values and the mapping 106, resulting in a tuned learning machine.

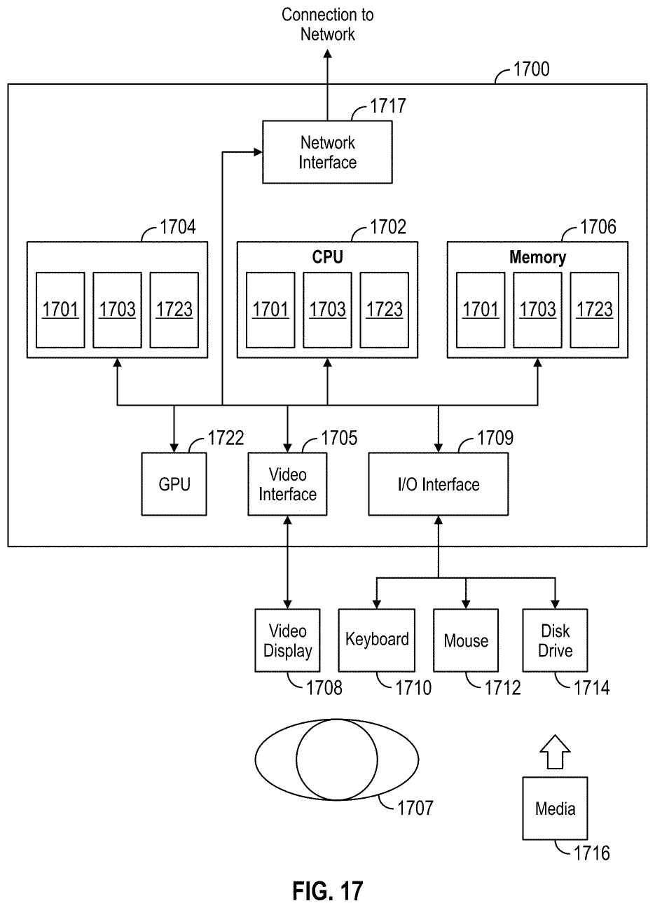

Those of skill in the art will understand that the systems and methods described herein may utilize a computing device, such as a computing device described with reference to FIG. 17 (see below), to perform the steps described above, and to store the results in memory or storage devices or be embodied as an integrated circuit or digital signal processor. Those of skill in the art will also understand that the steps disclosed herein can comprise instructions stored in memory of the computing device, and that the instructions, when executed by the one or more processors of the computing device, can cause the one or more processors to perform the steps disclosed herein. In some embodiments, the reference learning machine 101, the target learning machine being built 102, the set of test signals 103, the list of components to analyze 104, the mapping 106, and the tuned learning machine may be stored in a database residing on, or in communication with, the system 100. In some embodiments, the set of test signals 103, the list of components to analyze 104, the mapping 106 can be dynamically or interactively input.

In one aspect of some embodiments, within the component tuner module 107, a set of components C in the target learning machine 102 that were analyzed by the component analyzer module 105 can be updated by an update operation U based on the set of output values for each component (o_1\hat{ }1,o_1\hat{ }2, . . . o_1\hat{ }m, . . . , o_q\hat{ }1,o_q\hat{ }2, . . . o_q\hat{ }m) and the mapping 106 between the components from the reference learning machine and the components from the target learning machine (denoted by R):

C=U(R,o_1\hat{ }1,o_1\hat{ }2, . . . o_1\hat{ }m, . . . ,o_q\hat{ }1,o_q\hat{ }2, . . . o_q\hat{ }m),

where C denotes the tuned components associated with the components that were analyzed by the component analyzer module 105. In one aspect of some embodiments, with one embodiment of the update operation U, the tuned components C can be denoted as follows:

C=argmin_{C}∥O_{R,A_r}−O_{R,A_t,C}∥_p,

where ∥.∥_p is the Lp-norm, O_{R,A_r} denotes the set of output values of the analyzed components in reference learning machine A_r based on mapping R, and O_{R,A_t,C} denotes the corresponding set of output values of the analyzed components in target learning machine A_t (using a possible permutation of tuned components C) based on mapping R. Those of skill in the art will appreciate that other methods of updating the set of components C in the target learning machine 102 may be used in other embodiments, and the illustrative method as described above are not meant to be limiting.

In some embodiments, the tuned learning machine can then be fed back through a feedback loop 108 and used by the system 100 as the target learning machine in an iterative manner.

In some embodiments, the component analyzer module 105 and the component tuner module 107 may be embodied in hardware, for example, in the form of an integrated circuit chip, a digital signal processor chip, or on a computer. Learning machines may also be embodied in hardware in the form of an integrated circuit chip or on a computer. Thus, computer resources can be significantly conserved, and execution of code can be significantly improved.

In some embodiments, the target learning machine being built 102 may be a new component designed to be inserted into the reference learning machine 101 or to replace an existing set of components in the reference learning machine 101. These embodiments may allow existing learning machines to have their architectures modified, including but not limited to being modified dynamically over time.

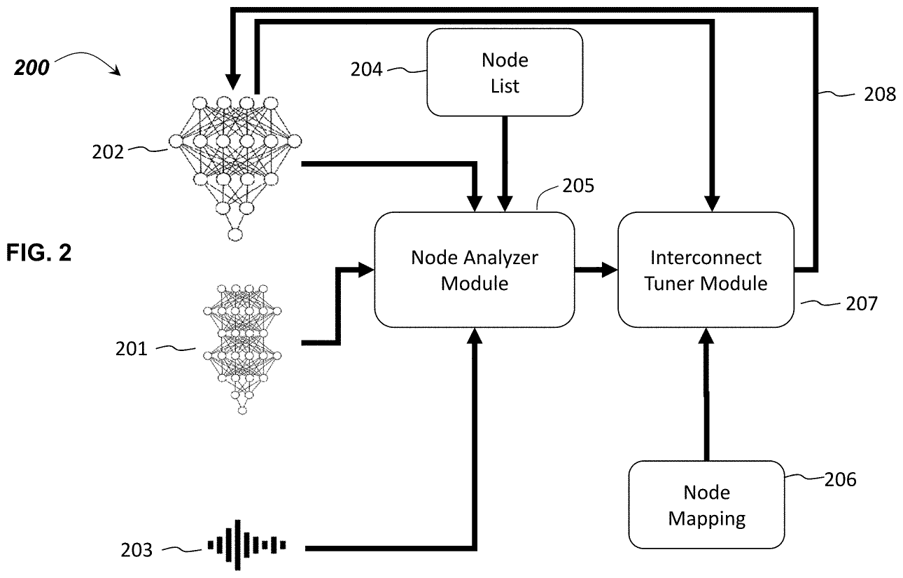

Turning to FIG. 2, an exemplary diagram of a system 200 for building learning machines is illustrated, according to some embodiments of the disclosure. In some embodiments, the learning machines in the system may be graph-based learning machines, including, but not limited to, neural networks, sum-product networks, Boltzmann machines, and Bayesian networks. The components may be nodes and interconnects. The component analyzer module may be a node analyzer module, and the component tuner module may be an interconnect tuner module.

With reference to FIG. 2, shown is a reference graph-based learning machine 201, a target graph-based learning machine being built 202, a set of test signals 203, a list of nodes to analyze 204, a node analyzer module 205, a mapping 206 between the nodes in reference graph-based learning machine 201 and the nodes in target graph-based learning machine 202, an interconnect tuner module 207, and a feedback loop 208. The reference graph-based learning machine 201 (A_r), the target graph-based learning machine 202 (A_t, the set of m test signals 203 (denoted as s_1,s_2, . . . s_m) and the list 204 of q nodes in the graph-based learning machines to analyze (denoted as n_1,n_2, . . . ,n_q) may be fed as inputs into the node analyzer module 205. The node analyzer module 205 may use the set of test signals 203 to analyze the graph-based learning machines 201 and 202, and may return a set of output values for each node on the list of nodes 204.

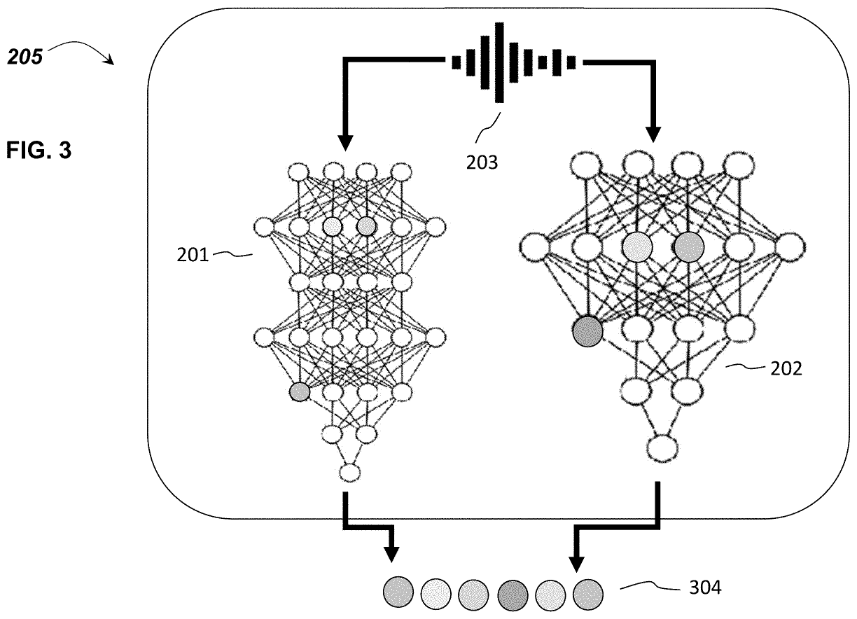

Turning to FIG. 3, an exemplary diagram of a node analyzer module 205 for building graph-based learning machines is illustrated, according to some embodiments of the disclosure. In some embodiments, within the node analyzer module 205, the set of test signals 203 (s_1,s_2, . . . ,s_m) may be passed into and propagating through both the reference graph-based learning machine 201 A_r and the target graph-based learning machine 202 A_t. For each test signal passed into the graph-based learning machines, the analyzer module 205 records the output values 304 of the graph-based learning machines 201 and 202 for the nodes specified in the list 204 (n_1,n_2, . . . ,n_q) as:

o_i\hat{ }j=f(n_i,s_j),

where o_i\hat{ }j denotes the output value of the i\hat{ }th node in the list of nodes 204 when the j\hat{ }th test signal is passed into and propagated through the graph-based learning machine that contains the i\hat{ }th node in the list of nodes 204, and f(n_i,s_j) computes the output value of the i\hat{ }th node in the list of nodes 204 when the j\hat{ }th test signal is passed into and propagated through the graph-based learning machine that contains the i\hat{ }th node in the list of nodes 204.

As a result, after passing all m test signals 203 through the graph-based learning machines 201 and 202, the output of the node analyzer module is a set of q output values for all m test signals, which can be denoted as o_1\hat{ }1,o_1\hat{ }2, . . . o_1\hat{ }m, . . . ,o_q\hat{ }1,o_q 2, . . . o_q\hat{ }m.

With reference to FIG. 2 again, the set of output values for each node (o_1\hat{ }1,o_1\hat{ }2, . . . o_1\hat{ }m, . . . ,o_q\hat{ }1,o_q\hat{ }2, . . . o_q\hat{ }m) that was analyzed by the node analyzer module 205, along with a mapping 206 (denoted as R) between the nodes from the reference graph-based learning machine 201 and the nodes from the target graph-based learning machine 202, and the target graph-based learning machine 202, can be passed as inputs into the interconnect tuner module 207. The interconnect tuner module 207 may modify the interconnects in the target graph-based learning machine 202 based on the set of output values (304 in FIG. 3) and the mapping 206, resulting in a tuned graph-based learning machine.

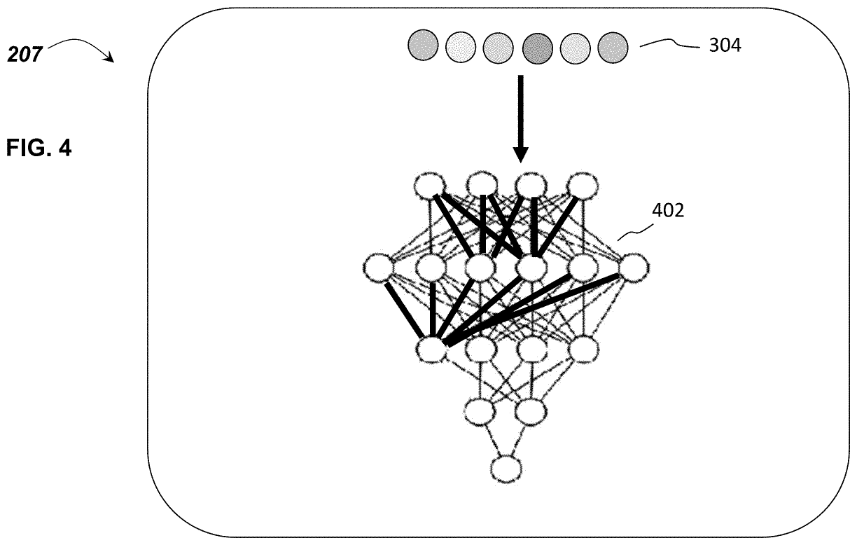

Turning to FIG. 4, an exemplary diagram of an interconnect tuner module 207 for building graph-based learning machines is illustrated, according to some embodiments of the disclosure. In some embodiments, within the interconnect tuner module 207, a set of interconnect weights W in the target graph-based learning machine 202 that are associated with the nodes 204 that were analyzed by the node analyzer module 205 can be updated by an update operation U based on the set of output values 304 for each node (o_1\hat{ }1,o_1\hat{ }2, . . . o_1\hat{ }m, . . . ,o_q\hat{ }1,o_q\hat{ }2, . . . o_q\hat{ }m) and the mapping 206 (denoted by R) between the nodes from the reference graph-based learning machine 201 and the nodes from the target graph-based learning machine 202. W can be denoted as:

W=U(R,o_1\hat{ }1,o_1\hat{ }2, . . . o_1\hat{ }m, . . . , o_q\hat{ }1,o_q\hat{ }2, . . . o_q\hat{ }m),

where W denotes the tuned weights of the interconnects associated with the nodes that were analyzed by the node analyzer module 205. In one aspect of some embodiments, with one embodiment of the update operation U, the tuned weights of the interconnects W can be as follows:

W=argmin_{W}∥O_{R,A_r}−O_{R,A_t,W}∥_p,

where ∥.∥_p is the Lp-norm, O_{R,A_r} denotes the set of output values of the analyzed nodes in reference graph-based learning machine A_r based on mapping R, and O_{R,A_t,W} denotes the corresponding set of output values of the analyzed nodes in target graph-based learning machine A_t (using a possible permutation of tuned weights W) based on mapping R. As illustrated in FIG. 4, as a result a tuned learning machine 402 is outputted from the interconnect tuner module 207. Those of skill in the art will appreciate that other methods of updating the set of interconnect weights W in the target graph-based learning machine 202 may be used in other embodiments, and the illustrative method as described above are not meant to be limiting.

Referring back to FIG. 2, in some embodiments, the tuned graph-based learning machine 402 can be fed back through a feedback loop 208 and can be used by the system and method as the target graph-based learning machine 202 in an iterative manner.

In an aspect of some embodiments, the target graph-based learning machine being built 202 may be a new component designed to be inserted into the reference graph-based learning machine 201. In another aspect of some embodiments, the target graph-based learning machine being built 202 may be a new component designed to replace an existing set of components in the reference graph-based learning machine 201. These embodiments may allow existing graph-based learning machines to have their architectures modified, including but not limited to being modified dynamically over time.

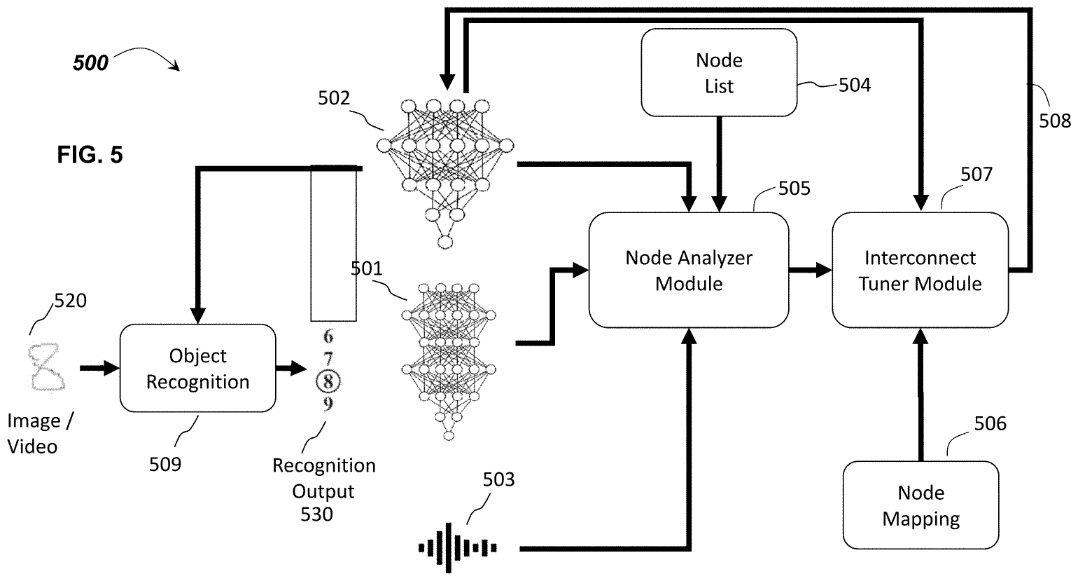

Turning to FIG. 5, an exemplary diagram of an illustrative system 500 for building learning machines is shown, according to some embodiments of the disclosure. As shown, the system 500 may include a reference graph-based learning machine 501, and a target graph-based learning machine 502 which is being built for a task 509 pertaining to object recognition from images or videos. In this illustrative example, the graph-based learning machines are neural networks, where the input into the neural network is an image 520 of a handwritten digit, and the output 530 of the neural network is the recognition decision on what number the image 520 of the handwritten digit contains. The nodes and interconnects within the neural network represent information and functions that map the input to the output of the neural network. In this example, the system 500 may include the reference neural network 501, the target neural network being built 502, a set of test signals 503, a list of nodes to analyze 504, a node analyzer module 505, a mapping 506 between the nodes in reference neural network and the nodes in target neural network, an interconnect tuner module 507, a feedback loop 508, and an object recognition subsystem 509.

In some embodiments, the reference neural network 501, the target neural network being built 502, the set of test signals 503, and the list of nodes in the neural networks to analyze 504 may be fed as inputs into the node analyzer module 505. The node analyzer module 505 may use the set of test signals 503 to analyze the neural networks 501 and 502, and may return a set of output values for each node on the list of nodes 504. The set of output values for each node that was analyzed, along with the mapping 506 between the nodes from the reference neural network and the nodes from the target neural network, and the target neural network 502, may be passed as inputs into the interconnect tuner module 507. The interconnect tuner module 507 may modify different interconnects in the target neural network based on the set of output values and the mapping 506, resulting in a tuned neural network. In some embodiments, the tuned neural network may then be fed back through a feedback loop 508 and used by the system and method as the target neural network 502 in an iterative manner. In some embodiments, whether to loopback may be determined by a predetermined number of iterations, for example, specified by a user or by a previous learning operation. In some other embodiments, whether to loopback may be determined by a predetermined performance criteria for the tuned learning machine to meet. In yet some other embodiments, whether to loopback may be determined by a predetermined error threshold between the performance of the tuned learning machine and the reference learning machine. Those of skill in the art will appreciate that other methods for determining whether to loopback may be used in other embodiments, and the illustrative methods as described above are not meant to be limiting.

The object recognition subsystem 509 may take in the target neural network 502, pass an image 520 of the handwritten digit into the network, and make a decision on what number the image 520 of the handwritten digit contains.

In one aspect of the illustrative system 500 above, the test signals 503 may be in the form of test images including different handwritten digits under different spatial transforms as well as different spatial patterns that underwent different spatial warping. The list of nodes 504 may include a list of nodes in the neural network associated with particular sets of visual characteristics of handwritten digits. For example, the list may include a set of four nodes from the target network 502 [nodes 1, 2, 3, 4] and a set of four nodes from the reference network 501 [nodes 11, 12, 13, 14] where these nodes characterize particular visual characteristics of handwritten digits. The mapping 506 may include a mapping between nodes from one neural network built for the purpose of visual handwritten digit recognition to nodes from another neural network built for the purpose of visual handwritten digit recognition. So, for example, a set of four nodes from the target network 502 [nodes 1, 2, 3, 4] may be mapped to a set of four nodes from the reference network 501 [nodes 11, 12, 13, 14] as follows:

R=[target node 1→reference node 11, target node 2→reference node 12, target node 3→reference node 13, and target node 4→reference node 14].

In another aspect of the illustrative system 500 above, the target neural network being built 502 may be a new set of nodes and interconnects designed to be inserted into the reference neural network 501 or to replace an existing set of nodes and interconnects in the reference neural networks 501.

### Automatic Building of Learning Machines Using Data

Other embodiments of the disclosure include systems and methods for building graph-based learning machines, including, for example, neural networks, sum-product networks, Boltzmann machines, and Bayesian networks. Generally, graph-based learning machines are node-based systems that can process samples of data to generate an output for a given input and learn from observations of the data samples to adapt or change. Graph-based learning machines typically include of a group of nodes (e.g., neurons in the case of neural networks) and interconnects (e.g., synapses in the case of neural networks). Generally, the system for building graph-based learning machines using data may include an initial reference graph-based learning machines, a machine analyzer module, and a machine architecture builder module. In some embodiments, the initial graph-based learning machine and a set of data are fed as inputs into the machine analyzer module. The machine analyzer module may use the data to analyze the importance of the different components of the initial graph-based learning machine (such as individual nodes, individual interconnects, groups of nodes, and/or groups of interconnects), and may generate a set of machine component importance scores. Using the generated set of machine component importance scores and a set of machine factors as inputs, a new graph-based learning machine architecture may then be built by the system using a machine architecture builder module. New graph-based learning machines may then be built such that their graph-based learning machine architectures are the same as the system-built graph-based learning machine architecture and may then be trained.

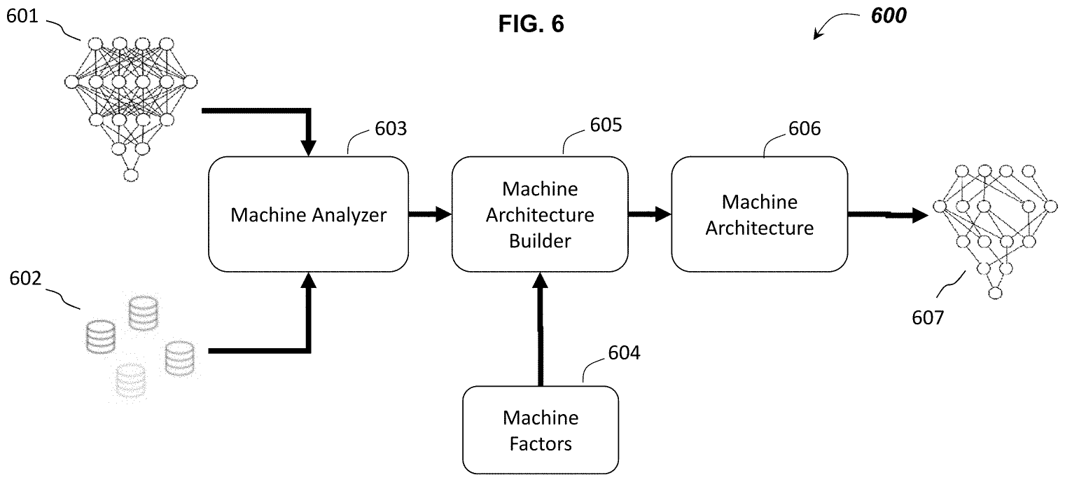

Turning to FIG. 6, an exemplary diagram of a system 600 for building graph-based learning machines using data is illustrated, according to some embodiments of the disclosure. In some embodiments, the system 600 may include a graph-based learning machine 601, a set of data 602, a machine analyzer module 603, a set of machine factors 604, a machine architecture builder module 605, and one or more generated graph-based learning machines 607. Those of skill in the art will understand that the systems and methods described herein may utilize a computing device, such as a computing device described with reference to FIG. 17 (see below), to perform the steps described herein, and to store the results in memory or storage devices or be embodied as an integrated circuit or digital signal processor. Those of skill in the art will also understand that the steps disclosed herein can comprise instructions stored in memory of the computing device, and that the instructions, when executed by the one or more processors of the computing device, can cause the one or more processors to perform the steps disclosed herein. In some embodiments, the graph-based learning machine 601, the set of data 602, the machine analyzer module 603, the set of machine factors 604, the machine architecture builder module 605, and the generated graph-based learning machines 607 may be stored in a database residing on, or in communication with, the system 600.

In some embodiments, the optimization of graph-based learning machine architecture disclosed herein may be particularly advantageous, for example, when embodying the graph-based learning machine as integrated circuit chips, since reducing the number of interconnects can reduce power consumption and cost and reduce memory size and may increase chip speed.

In some embodiments, the initial reference graph-based learning machine 601 may include a set of nodes N and a set of interconnects S, and a set of data 602 may be fed as inputs into the machine analyzer module 603. The initial graph-based learning machine 601 may have different graph-based learning machine architectures designed to perform different tasks; for example, one graph-based learning machine may be designed for the task of face recognition while another graph-based learning machine may be designed for the task of language translation.

In one aspect of some embodiments, the machine analyzer module 603 may use the set of data 602 to analyze the importance of the different machine components of the initial graph-based learning machine 601 and generates a set of machine component importance scores Q. A machine component may be defined as either an individual node n_i, an individual interconnect s_i, a group of nodes N_g,i, and/or a group of interconnects S_g,i).

### Computing Machine Component Importance Scores—Example One

In some embodiments, the machine analyzer 603 may compute the importance scores Q by applying the following steps (1) and (2). Those of skill in the art will understand that the method steps disclosed herein can comprise instructions stored in memory of the local or mobile computing device, and that the instructions, when executed by the one or more processors of the computing device, can cause the one or more processors to perform the steps disclosed herein.

(1) The initial graph-based learning machine 601 may be trained using a training method where, at each training stage, a group of nodes and interconnects in the graph-based learning machine (selected either randomly or deterministically) may be trained based on a set of data points from the set of data 602. In some embodiments, one or more nodes and one or more interconnects in the initial graph-based learning machine 601 may be trained, for example, by minimizing a cost function using optimization algorithms such as gradient descent and conjugate gradient, in conjunction with training methods such as the back-propagation algorithm. Cost functions such as mean squared error, sum squared error, cross-entropy cost function, exponential cost function, Hellinger distance cost function, and Kullback-Leibler divergence cost function may be used for training graph-based learning machines. The illustrative cost functions described above are not meant to be limiting. In some embodiments, one or more nodes and one or more interconnects in the initial graph-based learning machine 601 may be trained based on the desired bit-rates of interconnect weights in the graph-based learning machine, such as 32-bit floating point precision, 16-bit floating point precision, 32-bit fixed point precision, 8-bit integer precision, and 1-bit binary precision. For example, a group of nodes and interconnects in the initial graph-based learning machine 601 may be trained such that the bitrate of interconnect weights are 1-bit integer precision to reduce hardware complexity and increase chip speed in integrated circuit chip embodiments of the graph-based learning machine. In some embodiments, the training may take place in, but not limited to: a centralized system, a decentralized system composed of multiple computer systems and devices where training may be distributed across the systems, and a decentralized system where training may take place on a wide network of computer systems and devices using a blockchain where training of learning machines or different components of learning machines may be distributed across the systems and transactions associated with the trained learning machines or different components of the learning machines are completed and recorded in a blockchain. The illustrative training methods described above are also not meant to be limiting.

In some embodiments, the initial graph-based learning machine 601 may be used directly in Step (2) without the above training in Step (1).

(2) Given the initial graph-based learning machine 601 from Step (1), a machine component importance score q_C,j for each machine component C_j (with a machine component C_j defined as either an individual node n_j, an individual interconnect s_j, a group of nodes N_g,j, or a group of interconnects S_g,j) may be computed by applying the following steps (a) through (h).

(a) In some embodiments, each data point d_k in a set of data points from the set of data 602 is fed into the initial graph-based learning machine H for T iterations, where at each iteration a randomly selected group of nodes and interconnects in the graph-based learning machine may be tested using d_k to compute the output value of one of the nodes of the initial graph-based learning machine. The set of T computed output values for data point d_k are then combined together to produce a final combined output value (denoted by q_H,C,j,k) corresponding to data point d_k. Possible ways of combining the set of T computed output values may include: computing the mean of the output values, computing the weighted average of the output values, computing the maximum of the output values, computing the median of the output values, and computing the mode of the output values. This process is repeated for all data points in the set of data points from the set of data 602. In some embodiments, the number of iterations T may be determined based on the computational resources available and the performance requirements for the machine analyzer 603, as an increase in the number of iterations T may result in a decrease in the speed of the machine analyzer 603 but lead to an increase in accuracy in the machine analyzer 603.

(b) Next, in some embodiments, a full machine score q_H,C,j for each component C_j is computed by combining the final combined output values corresponding to all data points in the set of data points from the set of data 602 from Step (2)(a) above. Possible ways of combining the final combined output values may include: computing the mean of the final combined output values, computing the weighted average of the final combined output values, computing the maximum of the final combined output values, computing the median of the final combined output values, and computing the mode of the final combined output values.

(c) After a full machine score q_H,C,j for each component C_j is computed, a new reduced graph-based learning machine B may then be constructed, for example, by removing the machine component C_j from the initial graph-based learning machine 601.

(d) Next, each data point d_k in the set of data 602 may be fed into the new reduced graph-based learning machine B for T iterations, where at each iteration a deterministically or randomly selected group of nodes and interconnects in the graph-based learning machine B are tested using d_k to compute the output value of one of the nodes of the reduced graph-based learning machine. The set of T computed output values for data point d_k may then be combined together to produce a final combined output value (denoted by q_B,C,j,k) corresponding to data point d_k. Possible ways of combining the set of T computed output values may include: computing the mean of the output values, computing the weighted average of the output values, computing the maximum of the output values, computing the median of the output values, and computing the mode of the output values. This process may be repeated for all data points in the set of data points from the set of data 602.

(e) A reduced machine score q_B,C,j for each component C_j may then be computed by combining the final combined output values corresponding to all data points in the set of data points from the set of data 602 from Step (2)(d) above. Possible ways of combining the final combined output values may include: computing the mean of the final combined output values, computing the weighted average of the final combined output values, computing the maximum of the final combined output values, computing the median of the final combined output values, and computing the mode of the final combined output values.

(f) Next, in some embodiments, the machine component importance score corresponding to a specific data point d_k for each network component C_j (denoted by q_C,j,k) to indicate and explain the importance of each machine component C_j to the decision making process for data point d_k may be computed as:

q_C,j,k=q_H,C,j,k/(q_H,C,j,k+q_B,C,j,k).

(g) The machine component importance score q_C,j may be computed as:

q_C,j=q_H,C,j/(q_H,C,j+q_B,C,j).

(h) To compute the final set of machine component importance scores Q, for each node n_i in the graph-based learning machine, its corresponding machine component importance score q_n,i may be set to be equal to the machine component importance score of the component C_j that it belongs to. In a similar manner, for each interconnect s_i in the graph-based learning machine, its corresponding machine component importance score q_s,i may be set to be equal to the machine component importance score of the component C_j that it belongs to.

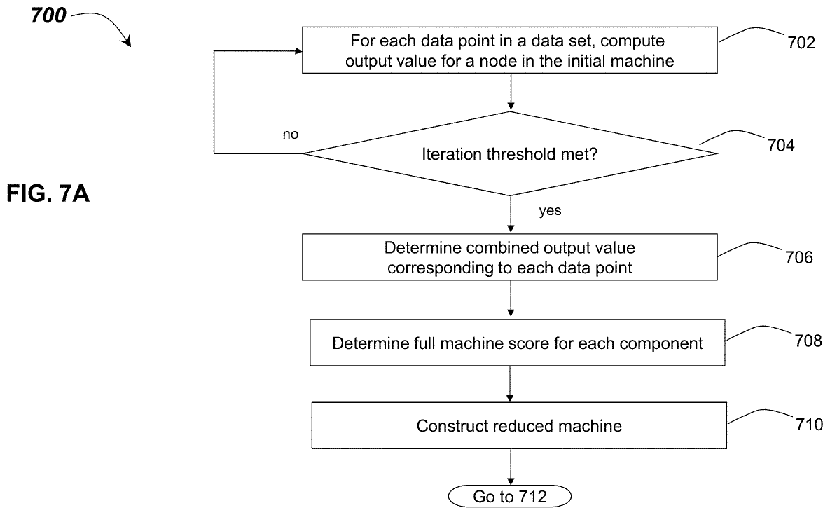

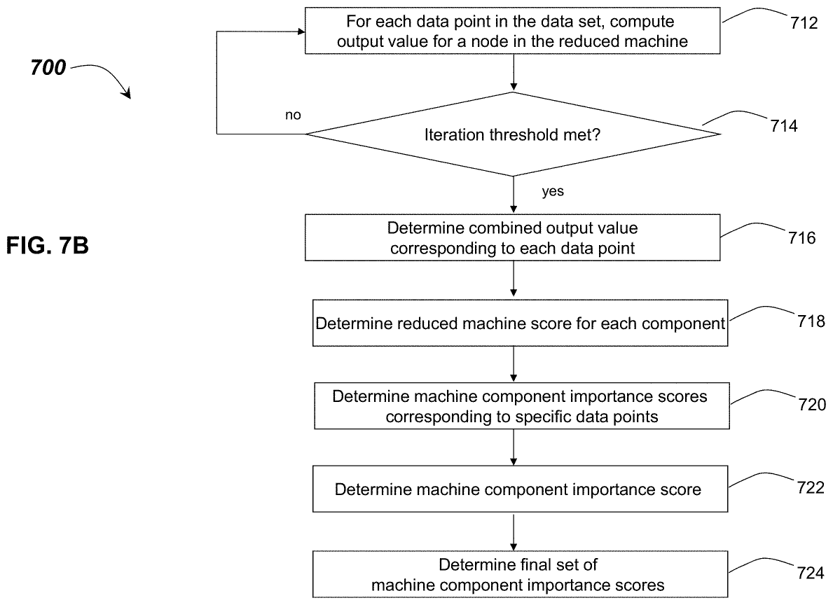

FIGS. 7A-7B illustrate an exemplary flow diagram 700 of Step (2)(a) through Step (2)(h) above. At Step 702, each data point d_k in a set of data points from the set of data 602 is fed into the initial graph-based learning machine (H), where at each iteration a randomly selected group of nodes and interconnects in the graph-based learning machine are tested using d_k to compute the output value of one of the nodes of the initial graph-based learning machine. At Step 704, if it is determined that the threshold T has not been reached for the number of iterations, Step 702 is repeated. At Step 706, if it is determined that the threshold T has been reached for the number of iterations (at Step 704), the set of T computed output values for data point d_k are then combined together to produce a final combined output value (q_H,C,j,k) corresponding to data point d_k. At Step 708, a full machine score q_H,C,j for each component C_j is computed by combining the final combined output values corresponding to all data points in the set of data points. At Step 710, a new reduced graph-based learning machine B may then be constructed.

At Step 712, each data point d_k in the set of data 602 is fed into the new reduced graph-based learning machine (B), where at each iteration a randomly selected group of nodes and interconnects in the graph-based learning machine B are tested using d_k to compute the output value of one of the nodes of the reduced graph-based learning machine. At Step 714, if it is determined that the threshold T has not been reached for the number of iterations, Step 712 is repeated. At Step 716, if it is determined that the threshold T has been reached for the number of iterations (at Step 714), the set of T computed output values for data point d_k are then combined together to produce combined output value (q_B,C,j,k) corresponding to data point d_k. At Step 718, a reduced machine score q_B,C,j for each component C_j is then computed.

At Step 720, machine component importance scores corresponding to specific data point d_k for each network component C_j are computed. At Step 722, the machine component importance score q_C,j is computed. Then at Step 724, the final set of machine component importance scores Q can be computed.

### Computing Machine Component Importance Scores—Example Two

In some embodiments, the machine analyzer 603 may compute the importance scores Q by applying the following steps (1) and (2). Those of skill in the art will understand that the method steps disclosed herein can comprise instructions stored in memory of the local or mobile computing device, and that the instructions, when executed by the one or more processors of the computing device, can cause the one or more processors to perform the steps disclosed herein.

(1) The initial graph-based learning machine 601 may be trained using a training method where, at each training stage, a group of nodes and interconnects in the graph-based learning machine 601 are trained based on a set of data points from the set of data 602. In some embodiments, one or more nodes and one or more interconnects in the initial graph-based learning machine 601 may then be trained, for example, by minimizing a cost function using optimization algorithms such as gradient descent and conjugate gradient, in conjunction with training methods such as the back-propagation algorithm. Cost functions such as mean squared error, sum squared error, cross-entropy cost function, exponential cost function, Hellinger distance cost function, and Kullback-Leibler divergence cost function may be used for training graph-based learning machines. The illustrative cost functions described above are not meant to be limiting. In some embodiments, one or more nodes and one or more interconnects in the initial graph-based learning machine 601 may be trained based on the desired bit-rates of interconnect weights in the graph-based learning machine, such as 32-bit floating point precision, 16-bit floating point precision, 32-bit fixed point precision, 8-bit integer precision, and 1-bit binary precision. For example, a group of nodes and interconnects in the initial graph-based learning machine 601 may be trained such that the bitrate of interconnect weights are 1-bit integer precision to reduce hardware complexity and increase chip speed in integrated circuit chip embodiments of the graph-based learning machine. In some embodiments, the training may take place in, but not limited to: a centralized system, a decentralized system composed of multiple computer systems and devices where training may be distributed across the systems, and a decentralized system where training may take place on a wide network of computer systems and devices using a blockchain where training of learning machines or different components of learning machines may be distributed across the systems and transactions associated with the trained learning machines or different components of the learning machines are completed and recorded in a blockchain. The illustrative training methods described above are also not meant to be limiting. In some embodiments, the initial graph-based learning machine 601 may be used directly in Step (2) without the above training in Step (1).

(2) Given the initial graph-based learning machine 601 from Step (1), the network component importance score q_C,j for each machine component C_j (with a network component C_j defined as either an individual node n_j, an individual interconnect s_j, a group of nodes N_g,j, or a group of interconnects S_g,j) is computed by applying the following steps (a) and (b).

(a) In some embodiments, each data point d_k in a set of data points from the set of data 602 may be fed into the initial graph-based learning machine (H) for T iterations, where at each iteration a selected group of nodes and interconnects in the graph-based learning machine may be tested using d_k to compute the output value of each component C_j in the initial graph-based learning machine. The set of T computed output values for data point d_k at each component C_j may then be combined together to produce a final combined output value (denoted by q_C,j,k) corresponding to data point d_k, with q_C,j,k denoting the machine component importance score corresponding to a specific data point d_k for each network component C_j to indicate and explain the importance of each machine component C_j to the decision making process for data point d_k. Possible ways of combining the set of T computed output values may include: computing the mean of the output values, computing the weighted average of the output values, computing the maximum of the output values, computing the median of the output values, and computing the mode of the output values. This process may be repeated for all data points in a set of data points from the set of data 602.

(b) The machine component importance score q_C,j for each component C_j may be computed by combining the final combined output values of C_j corresponding to all data points in the set of data points from the set of data 602 from Step (2)(a), and dividing that by a normalization value Z. Possible ways of combining the final combined output values of C_j corresponding to all data points in the set of data points from the set of data may include: computing the mean of the final combined output values, computing the weighted average of the final combined output values, computing the maximum of the final combined output values, computing the median of the final combined output values, and computing the mode of the final combined output values. Those of skill in the art will appreciate that other methods for generating the set of machine component importance scores using an initial reference graph-based learning machine and a set of data may be used in other embodiments and the description of the above described illustrative method for generating the machine component importance scores is not meant to be limiting.

Additionally, in some embodiments, for each data point d_k, a subset of machine component importance scores corresponding to that data point (denoted by Q_k={q_C,1,k, q_C,2,k, . . . , q_C,beta,k}, where beta is the number of machine components in a subset of machine components), may be mapped to corresponding input nodes (denoted by B={b_1,b_2, . . . , b_nu} where nu is the number of input nodes) using a mapping function M(q_C,j,k) and combined on a decision level using a combination function Y(Q_k|L) (where 1 denotes a possible decision from the set of possible decisions L) to compute the contributions of an input node b_i to each possible decisions in L that can be made by the graph-based learning machine (denoted by G(b_i|I)):

G(b_i|I)=Y(M(q_C,1,k),M(q_C,2,k), . . . ,M(q_C,beta,k)|I).

Those of skill in the art will appreciate that other methods for computing the contributions may be used in other embodiments and the description of the above described illustrative method for computing the contributions is not meant to be limiting.

Turning again to FIG. 6, in some embodiments, the set of machine component importance scores generated by the machine analyzer module 603 and a set of machine factors F 604 may be fed as inputs into the machine architecture builder module 605, which then may build a new graph-based learning machine architecture A 606. The set of machine factors F can be used to control the quantity of nodes and interconnects that will be added to the new graph-based learning machine architecture A (high values of F results in more nodes and interconnects being added to the new graph-based learning machine architecture, while low values of F results in fewer nodes and interconnects being added to the graph-based learning machine architecture) and therefore may allow greater control over the size of the new graph-based learning machine architecture A to control the level of efficiency.

In some embodiments, the machine architecture builder module 605 may perform the following operations for all nodes n_i in the set of nodes N to determine if each node n_i will exist in the new graph-based learning machine architecture A being built:

(1) Generate a random number X with a random number generator. (2) If the importance score of that particular node n_i (denoted by q_n,i), multiplied by network factor f_i corresponding to n_i, is greater than X, add n_i to the new graph-based learning machine architecture A being built.

The machine architecture builder module 605 may also perform the following operations for all interconnects s_i in the set of interconnects S to determine if each interconnect s_i will exist in the new graph-based learning machine architecture A being built:

(3) Generate a random number X with the random number generator.

(4) If the importance score of that particular interconnect s_i (denoted by q_s,i), multiplied by machine factor f_i, is greater than X, add s_i to the new graph-based learning machine A being built.

In some embodiments, the random number generator may generate uniformly distributed random numbers. Those of skill in the art will appreciate that other statistical distributions may be used in other embodiments.

In some embodiments, the machine architecture builder module 605 may perform the following operations for all nodes n_i in the set of nodes N to determine if each node n_i will exist in the new graph-based learning machine architecture A being built:

(1) If the importance score of that particular node n_i (denoted by q_n,i) is greater than one minus machine factor f_i, add node n_i to the new graph-based learning machine architecture A being built.

The machine architecture builder module 605 may also perform the following operations for all interconnects s_i in the set of interconnects S to determine if each interconnect s_i will exist in the new graph-based learning machine architecture A being built:

(2) If the importance score of that particular interconnect s_i (denoted by q_s,i) is greater than one minus machine factor f_i, add interconnect s_i to the new graph-based learning machine architecture A being built.

In some embodiments, after the above operations are performed by the machine architecture builder module 605, all nodes and interconnects that are not connected to other nodes and interconnects in the built graph-based learning machine architecture A may be removed from the graph-based learning machine architecture to obtain the final built graph-based learning machine architecture A. In some embodiments, this removal process may be performed by propagating through the graph-based learning machine architecture A and marking the nodes and interconnects that are not connected to other nodes and interconnects in the built graph-based learning machine architecture A, and then removing the marked nodes and interconnects. Those of skill in the art will appreciate that other methods for removal may be used in other embodiments.

Those of skill in the art will also appreciate that other methods of generating graph-based learning machine architectures based on a machine component importance model and a set of machine factors may be used in other embodiments, and the illustrative methods as described above are not meant to be limiting.

Still referring to FIG. 6, in some embodiments, based on the system-built graph-based learning machine architecture 606 from the machine architecture builder module 605, new graph-based learning machines 607 may then be built based on the system-built graph-based learning machine architectures 606 such that the graph-based learning machine architectures of these new graph-based learning machines 607 may be the same as the system-built graph-based learning machine architectures 606. In some embodiments, the new graph-based learning machines 607 may then be trained by minimizing a cost function using optimization algorithms such as gradient descent and conjugate gradient, in conjunction with training methods such as the back-propagation algorithm. Cost functions such as mean squared error, sum squared error, cross-entropy cost function, exponential cost function, Hellinger distance cost function, and Kullback-Leibler divergence cost function may be used for training graph-based learning machines. The illustrative cost functions described above are not meant to be limiting. In some embodiments, the graph-based learning machines 607 may be trained based on the desired bit-rates of interconnect weights in the graph-based learning machines, such as 32-bit floating point precision, 16-bit floating point precision, 32-bit fixed point precision, 8-bit integer precision, and 1-bit binary precision. For example, the graph-based learning machines 607 may be trained such that the bitrate of interconnect weights are 1-bit integer precision to reduce hardware complexity and increase chip speed in integrated circuit chip embodiments of a graph-based learning machine. In some embodiments, the training may take place in, but not limited to: a centralized system, a decentralized system composed of multiple computer systems and devices where training is distributed across the systems, and a decentralized system where training may take place on a wide network of computer systems and devices using a blockchain where training of learning machines or different components of learning machines may be distributed across the systems and transactions associated with the trained learning machines or different components of the learning machines are completed and recorded in a blockchain. The illustrative optimization algorithms and training methods described above are also not meant to be limiting.

In some other embodiments, the graph-based learning machines 607 may also be trained based on the set of machine component importance scores generated by the machine analyzer module 603 such that, when trained using data points from new sets of data outside of data points from the set of data 602, the interconnect weights with high machine importance scores have slow learning rates while the interconnect weights with low machine importance scores have high learning rates. An exemplary purpose of this is to avoid catastrophic forgetting in graph-based learning machines such as neural networks. An exemplary purpose of training the graph-based learning machines is to produce graph-based learning machines that are optimized for desired tasks.

In some embodiments, all interconnects in the graph-based learning machines 607 that have interconnect weights equal to 0 and all nodes that are not connected to other nodes and interconnects may then be removed from the graph-based learning machines. In some embodiment, this removal process may be performed by propagating through the graph-based learning machines and marking interconnects that have interconnect weights equal to 0 and all nodes that are not connected to other nodes and interconnects, and then removing the marked nodes and interconnects. Those of skill in the art will appreciate that other methods for removal may be used in other embodiments.

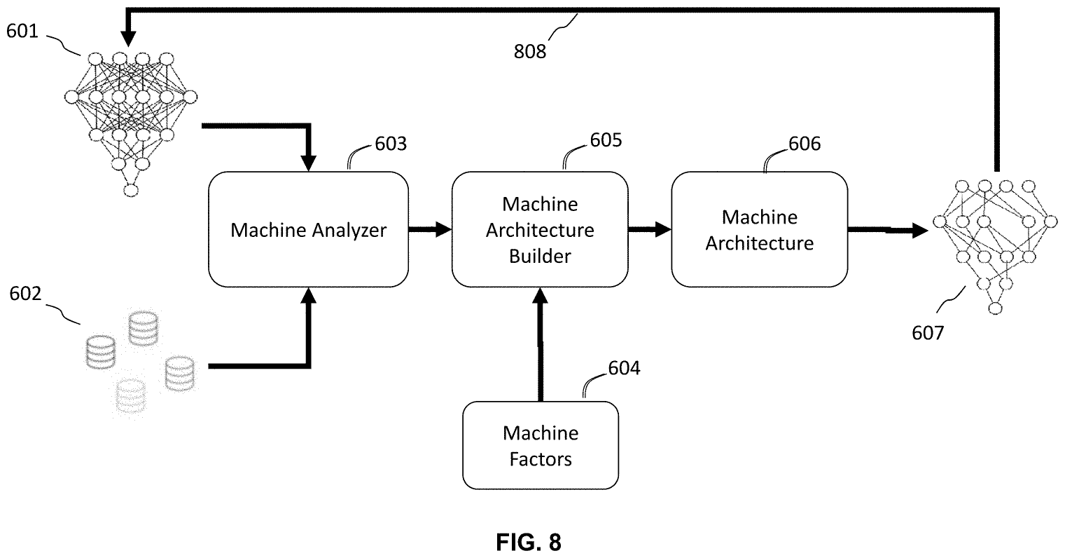

Turning to FIG. 8, in some embodiments, the new graph-based learning machines 607 may be fed back through a feedback loop 808 and used by the system and method as the initial graph-based learning machine 601 for building subsequent graph-based learning machines in an iterative manner by repeating the machine building process as described in FIG. 6.

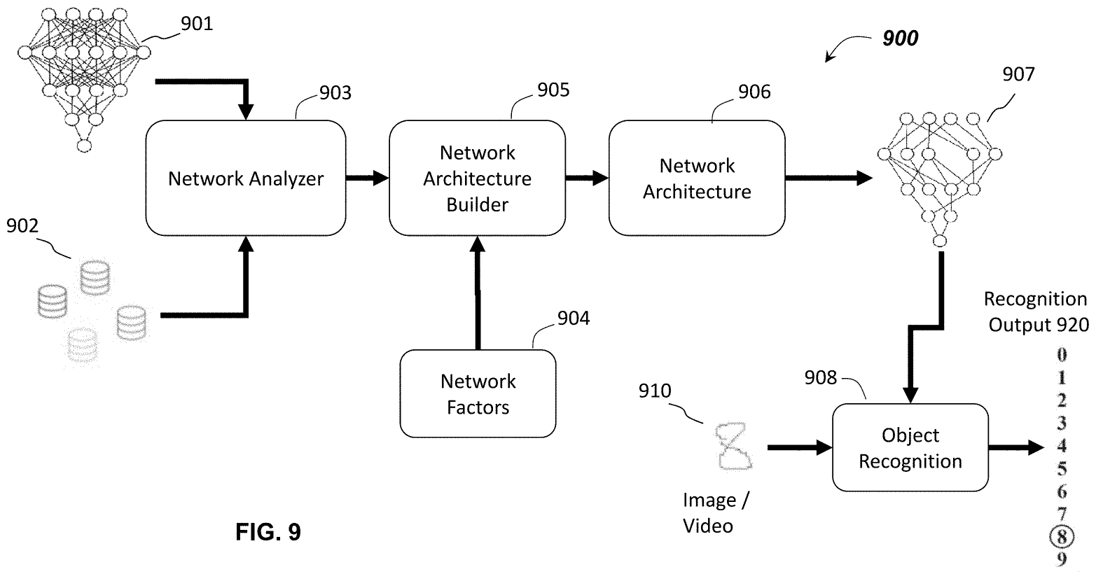

Turning to FIG. 9, a diagram of a system 900 illustrating an exemplary application of the system 600/800, according to some embodiments of the disclosure, is shown. In this example, the system 900 may be optimized for a task pertaining to object recognition and/or detection from images or videos. In this illustrative example, the graph-based learning machines are neural networks, where a machine analyzer module is a network analyzer module, a set of machine factors is a set of network factors, and a machine architecture builder module is a network architecture builder module. The system 900 may include an initial reference artificial neural network 901 for tasks pertaining to object recognition and/or detection from images or videos, a set of data 902, a network analyzer module 903, a set of network factors 904, a network architecture builder module 905, one or more generated neural networks 907 for tasks pertaining to object recognition and/or detection from images or videos, and an object recognition system 908.

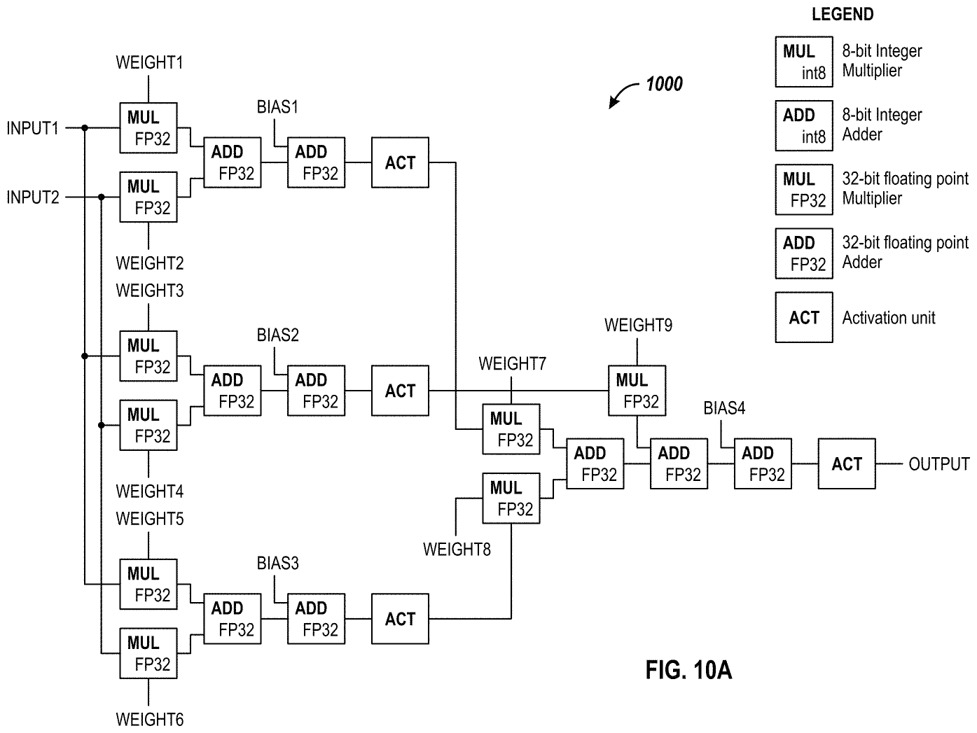

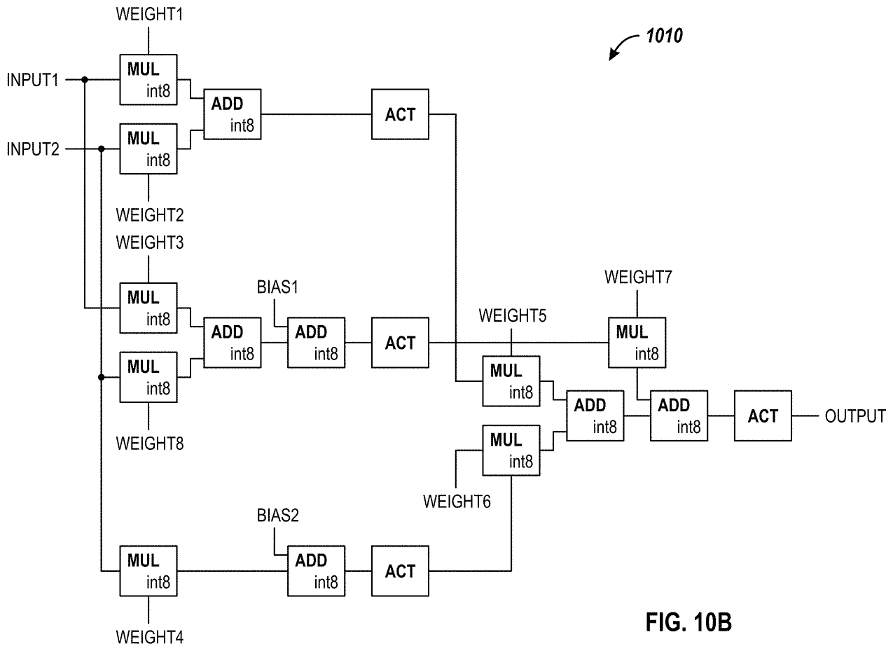

Turning to FIGS. 10A and 10B, FIG. 10A shows an exemplary schematic block diagram of an illustrative integrated circuit 1000 with a plurality of electrical circuit components that may be used to build an initial reference artificial neural network, which is a type of graph-based learning machine. FIG. 10B shows an exemplary schematic block diagram of an illustrative integrated circuit embodiment 1010 with a system-generated reduced artificial neural network built in accordance with the system and method of system 600. As shown, the integrated circuit embodiment 1010 with an artificial neural network built in accordance with the system and method of system 600 may require one fewer multiplier, three fewer adders, and two fewer biases compared to the integrated circuit of a reference artificial neural network. Furthermore, while the integrated circuit embodiment 1000 of the reference artificial neural network which includes 32-bit floating point adders and multipliers, the integrated circuit embodiment 1010 of the system-built artificial neural network built using the present disclosure includes 8-bit integer adders and multipliers which are advantageously faster and less complex. This illustrates how the present disclosure can be used to build artificial neural networks that have less complex and more efficient integrated circuit embodiments. Examples of the set of data (602) used in the illustrative integrated circuits 1000 and 1010 may include: data for rainfall prediction in the form of [INPUT1,INPUT2,OUTPUT]=[amount of rainfall on day 1, amount of rainfall on day 2, amount of rainfall on day 3], data for fruit ripeness prediction in the form of [INPUT1,INPUT2,OUTPUT]=[maximum width of fruit, weight of fruit, type of fruit], data for voice command identification in the form of [INPUT1,INPUT2,OUTPUT]=[spectral power between 330 Hz to 523 Hz, spectral power between 87 Hz to 329 Hz, type of voice command].

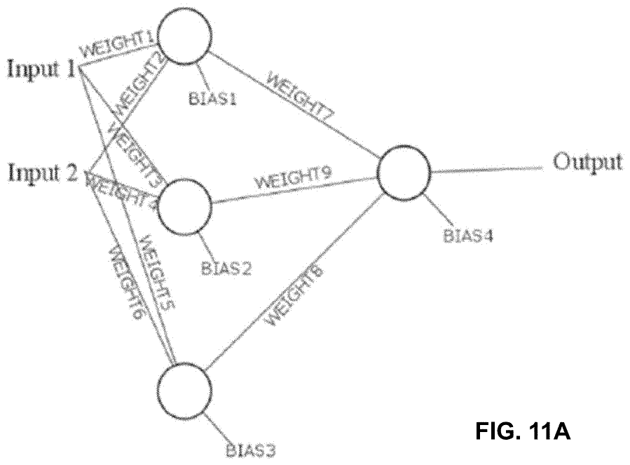

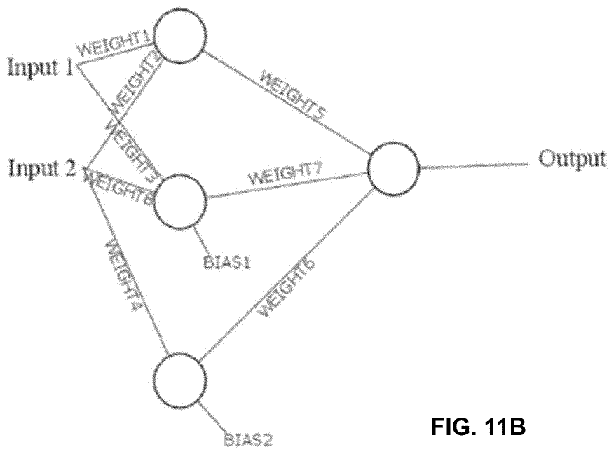

FIGS. 11A and 11B show examples of a reference artificial neural network 1100 corresponding to the FIG. 10A block diagram, and a more efficient artificial neural network 1110 built in accordance with the present disclosure corresponding to the FIG. 10B block diagram.

In some embodiments, various embodiments of systems and methods of the present disclosure may be combined for building learning machines.

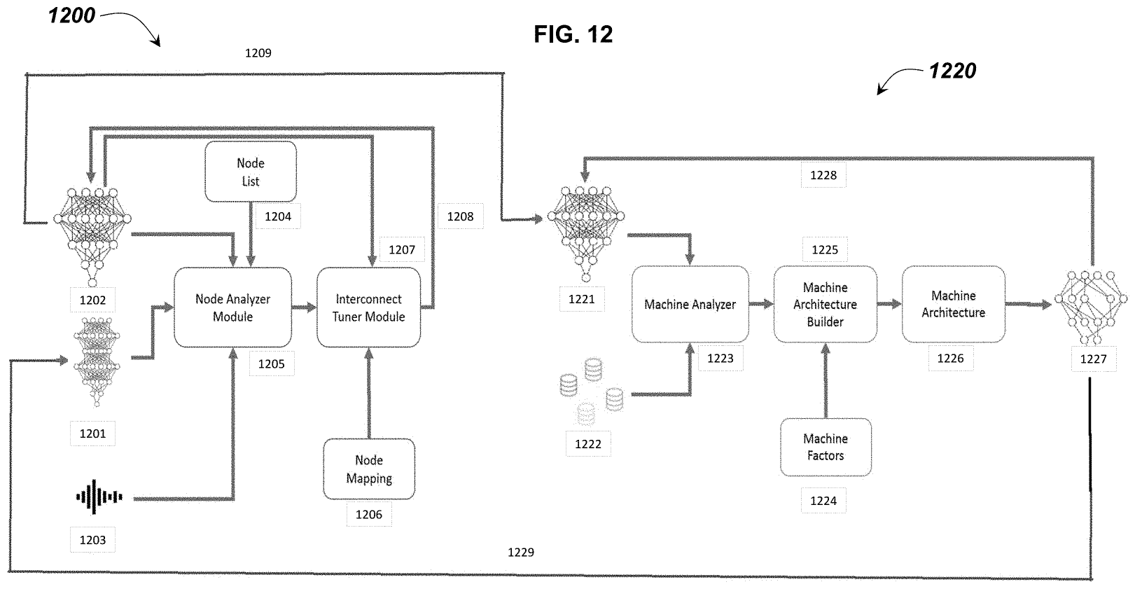

Turning to FIG. 12, an exemplary combination of embodiments of systems and methods of FIG. 2 and FIG. 8 may be combined for building graph-based learning machines, according to some embodiments of the disclosure. FIG. 12 illustrates an exemplary diagram of a system 1200 for building graph-based learning machines using graph-based learning machines, and a system 1220 for building graph-based learning machines using data. System 1200 may include a reference graph-based learning machine 1201, a target graph-based learning machine being built 1202, a set of test signals 1203, a list of nodes to analyze 1204, a node analyzer module 1205, a mapping 1206 between the nodes in reference graph-based learning machine 1201 and the nodes in target graph-based learning machine 1202, an interconnect tuner module 1207, and a feedback loop 1208. System 1220 may include a graph-based learning machine 1221, a set of data 1222, a machine analyzer module 1223, a set of machine factors 1224, a machine architecture builder module 1225, one or more generated graph-based learning machines 1227, and a feedback loop 1228.

In one aspect of some embodiments, the process of the system 1220 may be used first, followed by the process of the system 1200. In this example, one or more generated graph-based learning machines 1227 may be fed, using the feedback loop 1229, to the system 1200 as a reference graph-based learning machine 1201.

In another aspect of some embodiments, the process of the system 1200 may be used first, followed by the process of the system 1220. In this example, a target graph-based learning machine being built 1202 may be fed, using the connection 1209, to the system 1220 as a graph-based learning machine 1221.

Those of skill in the art will appreciate that the combination of systems and methods of the disclosure as illustrated in FIG. 12 may allow for a continuous and dynamic automatic building and training of learning machines.

Those of skill in the art will also appreciate that other combinations of embodiments of systems and methods of the present disclosure are also contemplated. The combination illustrated in FIG. 12 is not meant to be limiting.

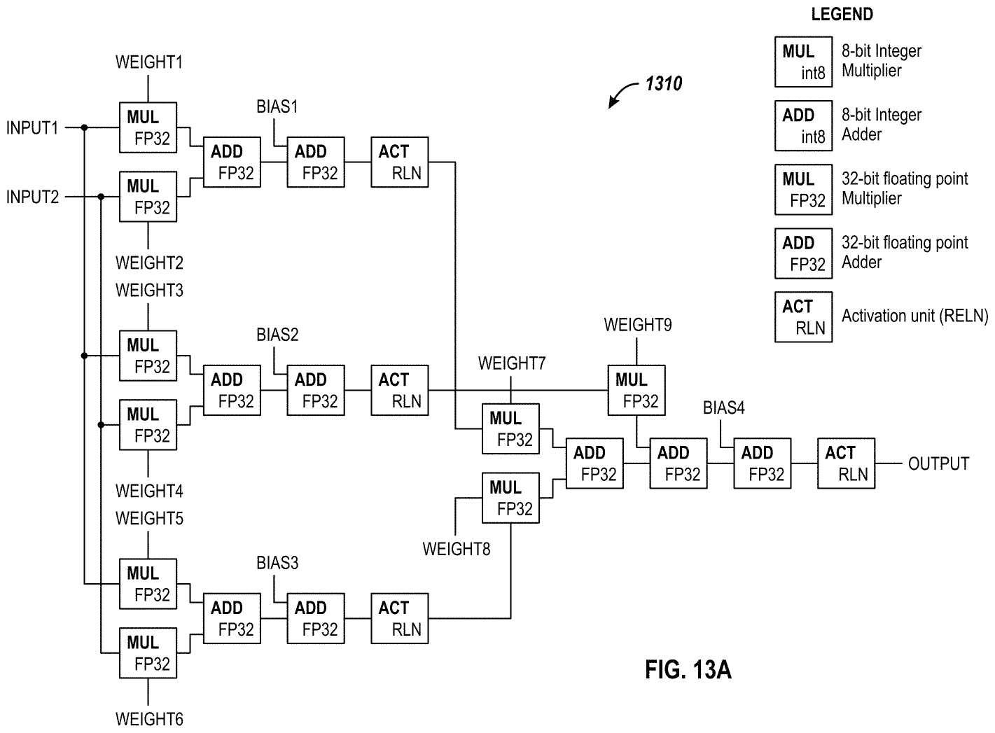

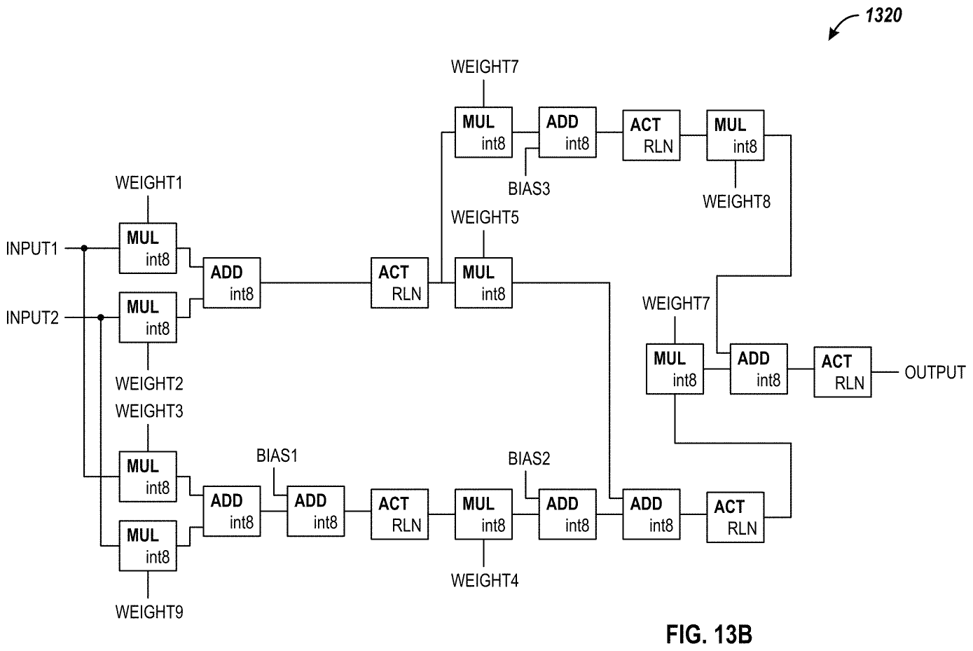

Turning to FIGS. 13A and 13B, FIG. 13A shows an exemplary schematic block diagram of an illustrative integrated circuit 1310 with a plurality of electrical circuit components that may be used to build an initial reference artificial neural network, a type of graph-based learning machine. FIG. 13B shows an exemplary schematic block diagram of an illustrative integrated circuit embodiment 1320 built in accordance to embodiments of FIGS. 12 (1200 and 1220). As shown, the integrated circuit embodiment 1320 with an artificial neural network built in accordance with the systems and methods 1200 and 1220 may require at least two fewer adders and one fewer bias compared to the integrated circuit of a reference artificial neural network (not shown). Furthermore, while the integrated circuit embodiment 1310 of the reference artificial neural network which includes 32-bit floating point adders and multipliers, the integrated circuit embodiment 1320 of the system-built artificial neural network built using the present disclosure includes 8-bit integer adders and multipliers which are advantageously faster and less complex. Furthermore, while the integrated circuit embodiment 1310 of the reference artificial neural network which includes TANH activation units (shown as ACT_{TANH}), the integrated circuit embodiment 1320 of the system-built artificial neural network built using the present disclosure includes RELU activation units (shown as ACT_{RELU}) which are advantageously faster and less complex. Furthermore, while the integrated circuit embodiment 1300 of the reference artificial neural network has a two layer architecture, the integrated circuit embodiment 1310 of the system-built artificial neural network built using the present disclosure has a three layer architecture which can provide higher accuracy and performance. This illustrates how the present disclosure can be used to build artificial neural networks that have less complex, more efficient, and higher performance integrated circuit embodiments.

### Automatic Building of Learning Machines Using Learning Machines and a Repository of Learning Machines

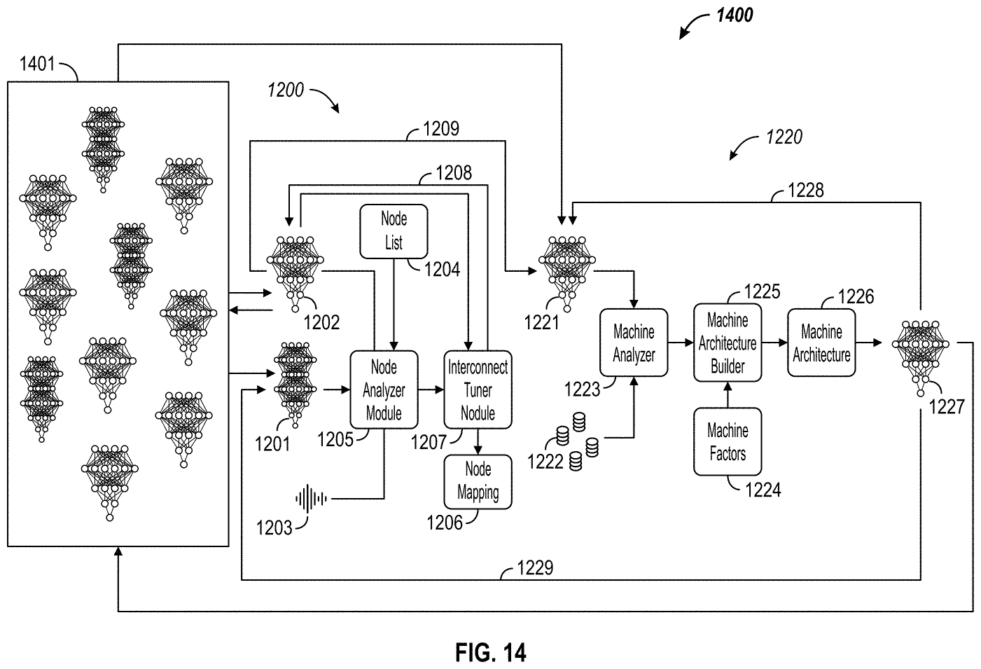

FIG. 14 illustrates an exemplary system 1400 for automatic building of learning machines using a repository of learning machines, according to some embodiments of the disclosure. System 1400 may include an exemplary combination of embodiments of systems and methods of FIGS. 2 (1200 and 1220) with the addition of a repository 1410 of learning machines to allow for the automatic building of learning machines using a repository of learning machines. In some embodiments, the repository 1410 of learning machines may include: a set of learning machines with different architectures designed for different purposes (for example, object detection, optical character recognition, speech recognition, image enhancement, image segmentation, stock market prediction, etc.), and a logic unit (not shown) for feeding learning machines into systems 1200 and 1220 from the repository, and retrieving learning machines from systems 1200 and 1220 into the repository 1410. In some embodiments, the logic unit in the repository 1410 of learning machines may feed a reference learning machine 1201 from the repository 1410 into a system 1200 for building learning machines using learning machines. In some embodiments, the logic unit in the repository 1410 of learning machines may feed a target learning machine 1202 into, or retrieve a target learning machine 1202 from a system 1200 for building learning machines using learning machines. Retrieved target learning machines 1202 may be stored back into the repository 1410 of learning machines. In some embodiments, the logic unit in the repository 1410 of learning machines may feed an initial learning machine 1221 into a system 1220 for building learning machines using data. In some embodiments, the logic unit in the repository 1410 of learning machines may retrieve a generated learning machine 1227 from a system 1220 for building learning machines using data. Retrieved generated learning machines 1227 may be stored back into the repository 1410 of learning machines. The repository 1410 of learning machines may allow for: 1. faster automatic building of learning machines by providing good initial learning machines for the system to leverage, 2. continuous automatic building of learning machines with better performance and/or efficiency over time, 3. automatic building of learning machines without the need to have a user-provided initial learning machine or a user-provided reference or target learning machine.

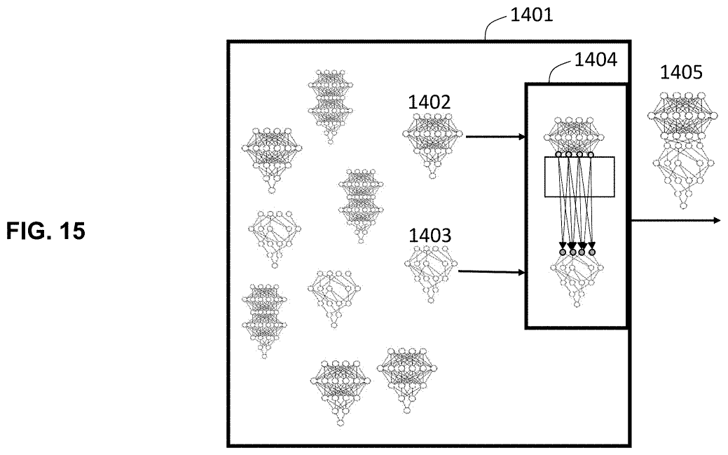

Referring to FIG. 15, in some embodiments, the logic unit in the repository of learning machines 1401 may take two or more learning machines from the repository 1401 and combines them into a single learning machine 1405 before feeding it as a target learning machine 1202 or a reference learning machine 1201 into a system 1200 for building learning machines using learning machines, or as an initial learning machine 1221 into a system 1220 for building learning machines using data. FIG. 15 illustrates exemplary embodiment of the logic unit combining two learning machines (1402 and 1403) from the repository of learning machines 1401. The logic unit performs the following operations (1404) to combine two learning machines (1402 and 1403) into a combined learning machine (1405):

1. Remove all the nodes and interconnects below a set of nodes from learning machine 1402.

2. Create a set of interconnects that connect a set of nodes from learning machine 1402 to the set of nodes from learning machine 1403.

Those of skill in the art will appreciate that other methods for combining two or more learning machines are also contemplated, and the above described method is not meant to be limiting.

In some embodiments, the combined learning machine may optionally be trained before being fed as a target learning machine 1202 or a reference learning machine 1201 into a system 1200 for building learning machines using learning machines, or as an initial learning machine 1221 into a system 1220 for building learning machines using data.

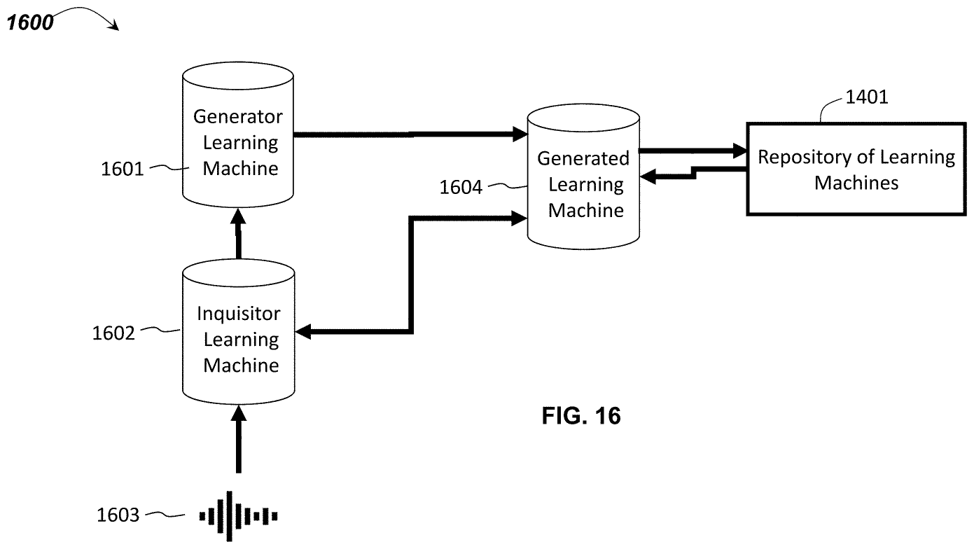

Turning to FIG. 16, an exemplary diagram of another system embodiment 1600 for building learning machines using learning machines and a repository of learning machines is illustrated, according to an embodiment of the disclosure. System 1600 may include a generator learning machine 1601, an inquisitor learning machine 1602, a set of test signals 1603, a generated learning machine 1604, and a repository of learning machines. The learning machines in the system may include: kernel machines, decision trees, decision forests, sum-product networks, Bayesian networks, Boltzmann machines, and neural networks. In one aspect of some embodiments, the generator learning machine 1601 may generate a generated learning machine 1604. The inquisitor learning machine 1602 may use test signals 1603 to probe the different components of the generated learning machine 1604. The inquisitor learning machine 1602 may use the information it obtains from probing the different components of the generated learning machine 1604 to update itself and transfer information to the generator learning machine 1601 to update the generator learning machine 1601. This process may be repeated in an iterative manner, with the generator learning machine 1601 repeatedly updated to generate better learning machines, the inquisitor learning machine 1602 repeatedly updated to gain better information from probing the different components of the generated learning machine 1604, and the repository of learning machines 1401 repeatedly updated with updated learning machines.

In some embodiments, at cycle k, a generator learning machine G (1601) with an internal state S_k(G) may generate a generated learning machine (1604) N_k, expressed by the following equation:

N_k=G(S_k(G)).

The inquisitor learning machine I (1602) with an internal state S_k(I) may then probe the generated learning machine N_k (1604) with a set of n probe signals alpha_1,alpha_2, . . . ,alpha_n, which returns a set of n reaction signals beta_1,beta_2, . . . ,beta_n, with each reaction signal beta composed of reactions from each component of the generated learning machine N_k (1604):

{beta_1,beta_2, . . . , beta_n}=I(N_k,{alpha_1,alpha_2, . . . ,alpha_n}|S_k(I)).

The inquisitor learning machine I (1602) may then update its internal state S_k(I) based on beta_1,beta_2, . . . , beta_n via an update function U:

S_{k+1}(I)=U(S_k(I)|beta_1,beta_2, . . . ,beta_n).

After the inquisitor learning machine I (1602) is updated, the inquisitor learning machine I (1602) may transfer information from its internal state S_k(I) to the generator learning machine G (1601) (thus leading to a change in internal state S_k(G)) via a transfer function T:

S_{k+1}(G)=T(S_k(G)|S_{k+1}(I)).

In some embodiments, the logic unit in the repository of learning machines 1401 may retrieve the generated learning machine N_k (1604) and stores it into the repository and may also feed a learning machine from the repository of learning machines as the generated learning machine N_k (1604). In some embodiments, this process may be repeated in an iterative manner over cycles, with the generator learning machine G 1601 repeatedly updated to generate better learning machines, the inquisitor learning machine I 1602 repeatedly updated to gain better information from probing the different components of the generated learning machine 1604, and the repository of learning machines 1401 repeatedly updated with updated learning machines.

Turning to FIG. 17, illustrated is an exemplary schematic block diagram of a generic computing device that may provide a suitable operating environment in one or more embodiments of the present disclosure. A suitably configured computer device, and associated communications networks, devices, software and firmware may provide a platform for enabling one or more embodiments as described above. By way of example, FIG. 17 shows a generic computer device 1700 that may include a central processing unit (“CPU”) 1702 connected to a storage unit 1704 and to a random access memory 1706. The CPU 1702 may process an operating system 1701, one or more application programs 1703, and data 1723. The operating system 1701, application programs 1703, and data 1723 may be stored in storage unit 1704 and loaded into memory 1706, as may be required. Computer device 1700 may further include a graphics processing unit (GPU) 1722 which is operatively connected to CPU 1702 and to memory 1706 to offload intensive processing, e.g., image processing calculations, from CPU 1702 and run this processing in parallel with CPU 1702. An operator 1710 may interact with the computer device 1700 using a video display 1708 connected by a video interface 1705, and various input/output devices such as a keyboard 1710, pointer 1712, and storage 1714 connected by an I/O interface 1709. In known manner, the pointer 1712 may be configured to control movement of a cursor or pointer icon in the video display 1708, and to operate various graphical user interface (GUI) controls appearing in the video display 1708. The computer device 1700 may form part of a network via a network interface 1711, allowing the computer device 1700 to communicate with other suitably configured data processing systems or circuits. A non-transitory medium 1716 may be used to store executable code embodying one or more embodiments of the present disclosure on the generic computing device 1700. The application programs 1703 and data 1723 may store executable code embodying one or more embodiments of the present disclosure.

A module as used herein may be embodied in software, e.g., software code or application program, or may be embodied in hardware, e.g., a computing device, an integrated circuit chip, a digital signal processor chip, etc.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “include” means “including, but not limited to,” or “include, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

It should be noted that where a discrete value or range of values is set forth herein (e.g., 5, 6, 10, 100, etc.), it is noted that the value or range of values may be claimed more broadly than as a discrete number or range of numbers, unless indicated otherwise. Any discrete values mentioned herein are merely provided as examples.

What is claimed is:

1. A system for building a learning machine, comprising:
a reference learning machine;
a target learning machine being built;
a component analyzer module configured to analyze inputs from the reference learning machine, the target learning machine, a set of test signals, and a list of components in the reference learning machine and the target learning machine, and return a set of output values for each component on the list of components; and
a component tuner module configured to modify different components in the target learning machine based on the set of output values and a component mapping, thereby resulting in a tuned learning machine.

2. The system of claim 1, further comprising a feedback loop for feeding back the tuned learning machine as a new target learning machine in an iterative manner.

3. The system of claim 1, wherein the target learning machine is a new component to be inserted into the reference learning machine.

4. The system of claim 1, wherein the target learning machine replaces an existing set of components in the reference learning machine.

5. The system of claim 1, wherein the reference learning machine and the target learning machine are graph-based learning machines.

6. The system of claim 5, wherein the component analyzer module is a node analyzer module.

7. The system of claim 5, wherein the component tuner module is an interconnect tuner module.

8. The system of claim 5, wherein the component mapping is a mapping between nodes from the reference learning machine and nodes from the target learning machine.

9. The system of claim 7, wherein the interconnect tuner module updates interconnect weights in the target learning machine.

10. The system of claim 1, wherein the tuned learning machine includes components updated by the component tuner module.

11. A system for building a learning machine, comprising:
an initial graph-based learning machine;
a machine analyzer configured to analyze components of the initial graph-based learning machine based on a set of data to generate a set of machine component importance scores; and
a machine architecture builder configured to build a graph-based learning machine architecture based on the set of machine component importance scores and a set of machine factors.

12. The system of claim 11, wherein a new graph-based learning machine is built wherein the architecture of the new graph-based learning machine is the same as the graph-based learning machine architecture.

13. The system of claim 12, further comprising a feedback loop for feeding back the new graph-based learning machine as a new initial graph-based learning machine in an iterative manner.

14. The system of claim 11, wherein the machine analyzer is further configured to:
feed each data point in a set of data points from the set of data into the initial graph-based learning machine for a predetermined set of iterations;
select groups of nodes and interconnects in the initial graph-based learning machine with each data point in the set of data points to compute an output value corresponding to each machine component in the initial graph-based learning machine;
compute an average of a set of computed output values of each machine component for each data point in the set of data points to produce a combined output value of each machine component corresponding to each data point in the set of data points; and
compute a machine component importance score for each machine component by averaging final combined output values of each machine component corresponding to all data points in the set of data points from the set of data and dividing the average by a normalization value.

15. The system of claim 11, wherein the machine analyzer is further configured to:
feed each data point in a set of data points from the set of data into the initial graph-based learning machine for a predetermined set of iterations;
randomly select groups of nodes and interconnects in the initial graph-based learning machine with each data point in the set of data points to compute an output value corresponding to one of the nodes of the initial graph-based learning machine;
average a set of computed output values for each data point in the set of data points to produce a final combined output value corresponding to each data point; and
compute a full machine score for each component in the initial graph-based learning machine by averaging a final combined output value corresponding to all data points in the set of data.

16. The system of claim 15, wherein the machine analyzer is further configured to:
feed each data point in the set of data points from the set of data into a reduced graph-based learning machine, with at least some machine components excluded, for a predetermined set of iterations;
randomly select groups of nodes and interconnects in the reduced graph-based learning machine with each data point in the set of data points to compute an output value corresponding to one of the nodes of the reduced graph-based learning machine;
compute an average of a set of computed output values for each data point to produce a final combined output value corresponding to each data point; and
compute a reduced machine score for each component in the reduced graph-based learning machine by averaging a final combined output value corresponding to all data points in the set of data points in the set of data.

17. The system of claim 11, wherein the machine architecture builder is further configured to control the size of the new graph-based learning machine architecture based on the set of machine component importance scores and the set of machine factors.

18. The system of claim 17, wherein the machine architecture builder controls the size of the new graph-based learning machine architecture by determining whether each node will exist in the new graph-based learning machine architecture.

19. A system for building a learning machine, comprising:
a reference learning machine;
a target learning machine being built;
a node analyzer module configured to analyze inputs from the reference learning machine, the target learning machine, a set of test signals, and a list of nodes in the reference learning machine and the target learning machine, and return a set of output values for each component on the list of nodes;
an interconnect tuner module configured to modify different components in the target learning machine based on the set of output values and a node mapping, thereby resulting in a tuned learning machine;
an initial graph-based learning machine;
a machine analyzer configured to analyze components of the initial graph-based learning machine based on a set of data to generate a set of machine component importance scores; and
a machine architecture builder configured to build a graph-based learning machine architecture based on the set of machine component importance scores and a set of machine factors.

20. The system of claim 19, wherein a new graph-based learning machine is built wherein the architecture of the new graph-based learning machine is the same as the graph-based learning machine architecture.
